(19) United States
(12) Patent Application Publication
(10) Pub. No.: US 2013/0103439 A1
(43) Pub. Date: Apr. 25, 2013

(54) SYSTEM AND METHOD FOR FACILITATING THE PURCHASE OF A TRAVEL ITINERARY SUBJECT TO DATE UNCERTAINTY

(71) Applicant: GETGOING, INC., San Francisco, CA (US)

(72) Inventors: Alek Vernitsky, San Francisco, CA (US); Alek Strygin, Granada Hills, CA (US); Ilya Gluhovsky, Daly City, CA (US)

(73) Assignee: GETGOING, INC., San Francisco, CA (US)

(21) Appl. No.: 13/656,466

(22) Filed: Oct. 19, 2012

Related U.S. Application Data
(60) Provisional application No. 61/549,892, filed on Oct. 21, 2011.

(51) Int. Cl. G06Q 50/14; G06Q 50/30

(52) U.S. Cl. 705/6; 705/5

(57) ABSTRACT

The disclosed embodiments relate to a system that facilitates a purchase of a travel itinerary subject to date uncertainty. This system is configured to receive a plurality of selected itineraries from a buyer, wherein the plurality of selected itineraries includes a first itinerary associated with a first set of dates and a second itinerary associated with a second set of dates. Next, upon receiving an agreement from the buyer to purchase an unspecified one of the plurality of selected itineraries, the system chooses one of the plurality of itineraries for the buyer and completes the purchase of the chosen itinerary on behalf of the buyer.

### CROSS-REFERENCE TO RELATED APPLICATIONS

This application claims priority under 35 U.S.C. section 119 to U.S. Provisional Patent Application No. 61/549,892, entitled “SYSTEM AND METHOD FOR SELLING TRAVEL AND HOSPITALITY INDUSTRY PRODUCTS UNDER SELECTION UNCERTAINTY,” by inventors Alek Vernitsky, Alek Strygin and Ilya Gluhovsky, filed 21 Oct. 2011, the contents of which are incorporated by reference herein. This application is also related to a co-pending U.S. patent application entitled “SYSTEM AND METHOD FOR FACILITATING THE PURCHASE OF A TRAVEL ITINERARY SUBJECT TO DESTINATION UNCERTAINTY,” by the same inventors as the instant application, filed on the same day as the instant application, patent application Ser. No. TO BE ASSIGNED (Attorney Docket No. GG12-1001).

### BACKGROUND

1. Technical Field

The embodiments herein generally relate to completing a purchase of a travel and hospitality product and, more particularly, to a system and method for completing a booking based on a plurality of travel itineraries added to a travel online shopping cart.

2. Description of the Related Art

Differential pricing, which includes product differentiation and price discrimination, is a pricing strategy commonly used by businesses for selling products like airline seats, hotel rooms, etc. Differential pricing is used to sell the right number of products to targeted customers for an appropriate price in order to maximize profit from a fixed, perishable resource. Price discrimination refers to the practice of charging different prices for the same (or very similar) products that have the same costs of production, based solely on different consumers' willingness to pay (WTP). Product discrimination, on the other hand, involves charging different prices for products with different quality of service characteristics and, in general, different costs of production. Most revenue systems utilize both price discrimination and product differentiation in an attempt to maximize yield. They offer a variety of products, involving differences in the quality of services, as well as differences in the purchase according to conditions and restrictions.

Another strategy is market segmentation, which refers to classifying individuals or identifying different demand groups or segments. Market segmentation techniques are used in order to maximize revenues from sale of a fixed, perishable commodity, such as a seat on an airline, a hotel room, cruises, car rental, or any other such products. In theory, total revenue from a product is maximized when each consumer pays a different price equal to his or her WTP. In practice, such a theoretical segmentation cannot be achieved as the system cannot determine each individual WTP for each particular product, nor can it publish different prices available only to specific individuals.

FIG. 1A illustrates a price demand curve used for price differentiation in airlines. The entire area under the sloping line represents the maximum revenue that an airline may derive from a given flight. If the airline offers an unrestricted fare P1 (price) to those consumers with a higher WTP, the airline can expect Q1 (quantity) consumers to purchase the fare because they have WTP equal to P1 or greater. However, the airline may leave a lot of revenue on the table, both because it did not charge a higher price for those consumers who have WTP>P1, and also because a number of seats are flying empty, as many consumers with WTP<P1 did not buy a ticket.

FIG. 1B illustrates a graphical representation of a typical differential pricing technique of a product. If the airline offers a lower or discount fare P2 to those consumers with a lower WTP, then Q2-Q1 additional consumers would be expected to purchase the lower fare, as they have WTP greater than P2 but less than P1. By introducing two fares, the airline is able to capture a greater portion of the total available revenue. This model assumes that consumers with a high WTP purchase the higher fare P1. Due to the challenges of identifying and segmenting customers based on the strength of their preference for a specific product, there are price discrimination challenges. Because of this, profit or yield is reduced and, in turn, there is not much market for the product.

For example, consumers prefer high-quality goods over low-quality goods, if prices for all goods are the same. By introducing products of different quality and at different prices, the airlines try to segment the market into consumers with higher and lower WTP. First class, business, premium economy, and economy cabins, as well as tickets that come with expedited security services, priority boarding, and lounge access, are all examples of the product differentiation. Fare classes and fare basis codes are the most important yield management innovation introduced by the airlines. Each cabin (first, business, and coach) has a number of fare classes—typically eight or more for coach, one or two for business, and one or two for first. Each fare class is used to book tickets sold under different fare codes or fare basis codes.

There are different approaches used by airline service providers to sell tickets with offers which yield profits and also optimize the revenue and managing inventory for the airline, thus ensuring to supply consumers with best products for which they are willing to pay. For example, a prospective purchaser purchasing an airline ticket may commit to purchasing an airline ticket at a reduced price, but the transaction may only occur if the seller makes the ticket available at a designated time near the date of departure. In such scenarios, the utility in a commercial sale of airline tickets is limited. First, the buyer is required to make a commitment in advance without any certainty of getting on a flight.

Second, the buyer is effectively precluded from booking a hotel at his chosen destination because of the uncertainty that the trip will occur, and booking a last-minute hotel may offset any savings from the discounted airfare. Third, on routes with frequent last-minute seat availability, many buyers are likely to adjust their behavior and postpone the full price purchase in favor of an acquisition uncertainty ticket. This creates more empty seats and perpetuates a vicious cycle. Thus, the consumer is not sure whether the ticket will be booked or not till near the date of departure.

The other approach of revenue management by airlines is, for example, a Name-Your-Own-Price® (NYOP®) distribution platform that sells opaque fares through buyer-driven pricing. In this NYOP platform, a customer makes a conditional purchase offer by specifying some characteristics of the itinerary (such as origin, destination, and dates) and the price he/she is willing to pay. The request is a commitment by the customer to buy at the offered price. Once the request is made, the Priceline® system searches for an airline that is willing to sell a flight ticket below that price and sends an accept/reject decision back to the customer within a specific time period. If the airline accepts the offer (i.e., a fare exists at or below the buyer-requested price), the flight is booked and the customer is charged. Priceline® keeps the margin between the customer-quoted price and the airline price.

Hotwire® offers a platform where, instead of buyer-driven pricing, the price is disclosed upfront, while the details of the itinerary remain opaque until after the purchase. The opaque sales channels are inferior, both from the airline perspective and from the customer perspective. The opaqueness of the fare downgrades the product by making it less valuable in an attempt to discourage consumption by the high-WTP customers. NYOP® customers must accept considerable uncertainty over the details of their itinerary, including not knowing the airline they will fly, the number of connections, or the exact times of arrival and departure.

In Priceline®'s implementation, customers are also required to guess the price of an airline ticket and, in an attempt to discourage repeat bidding, wait for a period of time before making another offer. Thus, a buyer may be required to spend a considerable amount of time only to end up with a suboptimal product. In addition, many high-WTP customers exhibit low-WTP behavior. While some business and leisure travelers are likely to be discouraged by the deliberate uncertainty introduced into the transaction (in terms of arrival time, routing, and number of stops), many others will perceive the opaque fare as a perfect substitute for the non-opaque fare that allows the buyer to travel from origin to destination and return on the specified dates, resulting in the cannibalization of high-WTP fares, including business fares.

Prepaid airline tickets are made available for purchase in advance of the flights so that the buyer may convert to a specific flight itinerary shortly before the departure, within certain specified parameters (such as a range of dates, a type of seat, etc.), and subject to seat availability. Unlike the unspecified-time ticket, the buyer is not forced to accept whatever flight and seat the airline offers, and has more flexibility to choose within a range of seats available at the very last minute. For both seller- and buyer-driven prepaid tickets, the buyer does not have the certainty of ticket availability until the last minute. Also, the itinerary is either opaque (some but not all of its attributes are known) or, if not opaque, may present the buyer with a limited selection of last-minute unsatisfactory choices. Hence, there remains a need for market segmentation and consequent price differentiation while balancing the interests of the airline and/or travel website, as well as those of the customer.

### SUMMARY

In view of the foregoing, an embodiment herein provides a method of completing a booking based on two or more travel itineraries added to a travel online shopping cart. The method includes: processing, from a buyer, the two or more travel itineraries and two or more destinations in the travel online shopping cart; processing, from the buyer, at least: (i) travel party information, and (ii) payer information for two or more travel itineraries and two or more destinations; obtaining an agreement from the buyer (i) to buy a subset of a) the two or more travel itineraries, and b) the two or more destinations in the travel online shopping cart, and (ii) to a penalty for subsequently canceling the booking; selecting, by a provider, based on one or more predefined rules specified by the provider, at least one destination from the two or more destinations in the travel online shopping cart to obtain a selected destination; processing, from the buyer, at least one travel itinerary from two or more itineraries that corresponds to the selected destination when the buyer is notified of the selected destination; performing a monetary transaction to complete the booking for the at least one travel itinerary and the selected destination; and communicating that the at least one travel itinerary and the selected destination has been purchased by the buyer. The two or more itineraries and the two or more destinations are diverse enough as a set based on a plurality of business rules.

The travel party information includes one or more travelers. Each of the one or more travelers is booked into the at least one travel itinerary and the selected destination. A fare for the at least one travel itinerary and the selected destination may be lower than an open market fare that corresponds to the at least one travel itinerary and the selected destination. A validity of the travel online shopping cart may be determined by the buyer based on the set of business rules. The at least one travel itinerary is an air travel itinerary that includes a package. The package may include an air travel ticket, a hotel room, a car rental, or any other travel-related products.

The travel online shopping cart may include exactly two travel itineraries. Each of the two or more travel itineraries in the travel online shopping cart may have a different destination. Moreover, each of the different destinations may serve a different regional market. A subset of the two or more travel itineraries may overlap, wherein the amount of the overlap may be subject to a rule set by the provider. Also, each of the two or more travel itineraries may have the same travel date. Alternatively, the two or more travel itineraries may have significantly different spans of dates. Additionally, each of the two or more travel itineraries in the travel online shopping cart may have the same destination.

A subset of the two or more travel itineraries may include air travel details that are opaque. A portion of the itinerary details of the subset may be hidden for a substantial period of time when displayed to the buyer. The air travel details may include (i) operating or marketing carrier details, and (ii) departure dates. Details of the at least one travel itinerary and the selected destination may be displayed to the buyer only after performing the monetary transaction.

A list of travel products may be dynamically adjusted and displayed to the buyer based on a progressive population or deletion of two or more travel itineraries from the travel online shopping cart. The list of travel products may be dynamically adjusted based on at least one adjustment criterion. The at least one adjustment criterion may be a distance between destination airports. The list of travel products may be dynamically adjusted based on a set of airlines marketing or operating flights already in the travel online shopping cart as compared to (i) marketing candidate flights or (ii) operating candidate flights.

The provider may select the at least one destination based on (i) a revenue optimization algorithm, (ii) an inventory management algorithm, (iii) an increasing consumer surplus algorithm, or (iv) combinations thereof to solve a multi-objective optimization problem. The buyer may indicate an affinity for each of the two or more travel itineraries and the two or more destinations in the travel online shopping cart. The at least one itinerary and the selected destination may be selected based on the affinity indicated by the buyer.

The monetary transaction for the selected destination is (i) not exchangeable, (ii) not refundable, (iii) not transferable, or (iv) not reimbursable, in full or in part. The at least one travel itinerary is selected by the buyer based on a voucher or a promotional code provided by the provider when the selected destination is obtained. A deposit may be obtained to perform the monetary transaction. A balance may be obtained from the buyer, upon the buyer's selection of the at least one itinerary. The balance is calculated based on an actual itinerary chosen.

In another embodiment, a portal server for completing a booking based on two or more travel itineraries added to a travel online shopping cart is provided. The portal server includes a database that stores two or more travel itineraries and two or more destinations received from a buyer. The two or more travel itineraries and the two or more destinations are diverse enough as a set based on a plurality of business rules. At least (i) travel party information and (ii) payer information for the two or more destinations is obtained from the buyer. An agreement is obtained from the buyer (i) to buy a subset of a) the two or more travel itineraries and b) the two or more destinations in the travel online shopping cart, and (ii) to a penalty for subsequently canceling the booking A product selection module is configured to select at least one destination from the two or more destinations in the travel online shopping cart to obtain a selected destination based on one or more predefined rules specified by a provider. At least one travel itinerary from the two or more itineraries is obtained from the buyer that corresponds to the selected destination when the buyer is notified of the selected destination. A transaction module is configured to perform a monetary transaction to complete the booking for the at least one travel itinerary and the selected destination. A communication module is configured to communicate that the at least one travel itinerary and the selected destination has been purchased by the buyer.

The communication module may further communicate details associated with the at least one travel itinerary and the selected destination. The communication module may further communicate one or more ancillary services for the at least one travel itinerary and the selected destination. The buyer may indicate an affinity for each of the two or more travel itineraries and two or more destinations in the travel online shopping cart. The at least one itinerary and the selected destination may be selected based on the affinity indicated by the buyer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates a price demand curve used for price differentiation in airlines;

FIG. 1B illustrates a graphical representation of a typical differential pricing technique of a product;

FIG. 2 is a system view illustrating a buyer interacting with a product selection server and a provider through a network to complete a booking based on two or more travel itineraries added to a travel online shopping cart according to an embodiment herein;

FIG. 3 illustrates an exploded view of the product selection server of FIG. 2 according to an embodiment herein;

FIG. 4 is a user interface view of the product selection server of FIG. 2 illustrating a comparison of two travel itineraries according to an embodiment herein;

FIG. 5 is a user interface view of the product selection server of FIG. 2 illustrating a method of processing from the buyer travel party information and payer information for the two or more travel itineraries and the two or more destinations to perform a monetary transaction to complete the booking for at least one travel itinerary and the selected destination according to an embodiment herein;

FIG. 6 is a user interface view of the product selection server of FIG. 2 illustrating a method of completing a booking or transaction for one of the two destinations according to an embodiment herein;

FIG. 7 is a user interface view of the product selection server of FIG. 2 illustrating a method of sending a confirmation message that indicates that the at least one travel itinerary and the selected destination has been purchased by the buyer according to an embodiment herein;

FIG. 8A is a block diagram illustrating an integration of the product selection server of FIG. 2 within a product portal of an airline service provider according to an embodiment herein;

FIG. 8B illustrates a flow diagram of completing a booking for a selected destination on a third-party web page according to an embodiment herein;

FIG. 9 is a graphical representation illustrating a revenue-optimal selection probability of a product from the pool of substitutable product options according to an embodiment herein;

FIG. 10 illustrates a schematic of a computer architecture used in accordance with the embodiments herein; and

FIG. 11 is a flow diagram illustrating a method of completing a booking based on two or more travel itineraries added to a travel online shopping cart according to an embodiment herein.

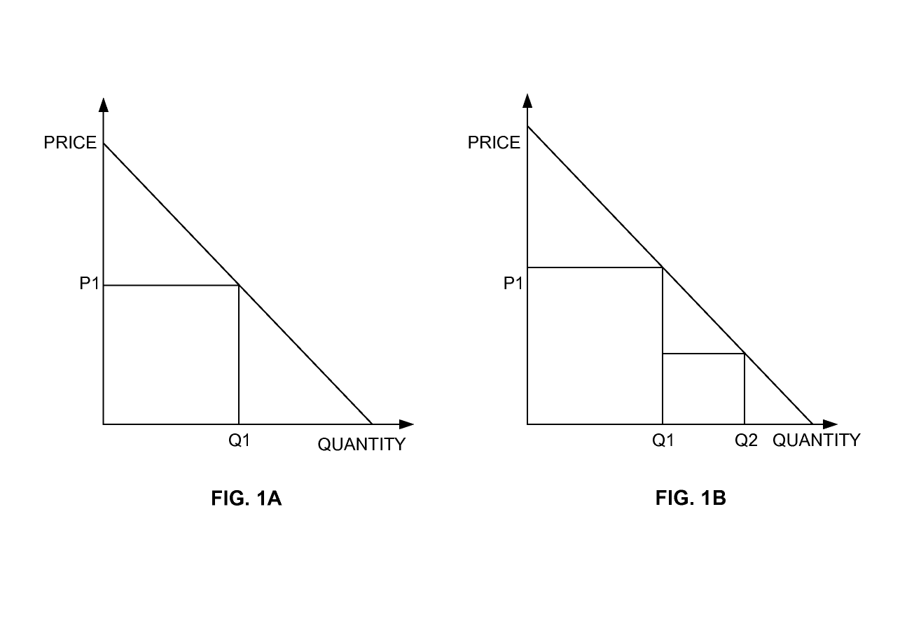

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

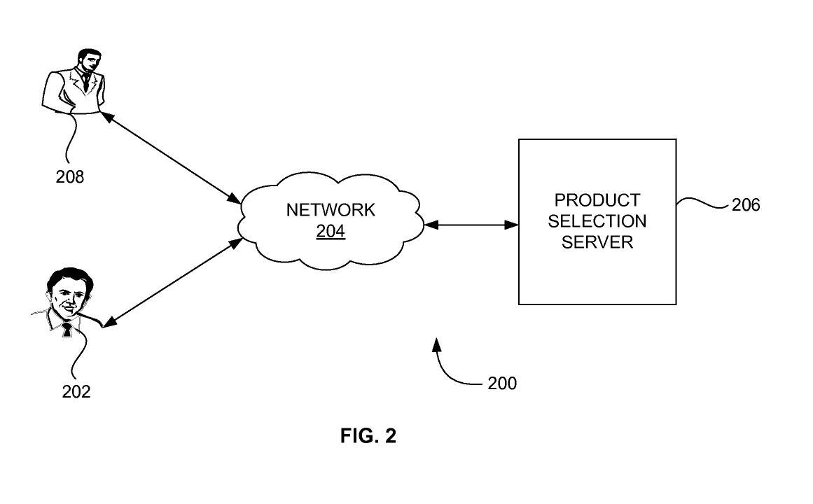

As mentioned, there remains a need for market segmentation and consequent price differentiation while balancing the interests of the airline and/or travel website, as well as those of the customer. The embodiments herein achieve this by providing a system and method for completing the purchase of the product from one or more products added to an online shopping cart. Referring now to the drawings, and more particularly to FIGS. 2-11, where similarly referenced characters denote corresponding features consistently throughout the figures, there are shown preferred embodiments.

FIG. 2 is a system view illustrating a buyer 202 interacting with a product selection server 206 and a provider 208 through a network 204 to complete a booking based on two or more travel itineraries added to a travel online shopping cart according to an embodiment herein. The buyer 202 may create a profile on the product selection server 206 which is made accessible to the provider 208. The buyer 202 selects two or more travel itineraries to add to the travel online shopping cart. The one or more travel itineraries may include two or more destinations that are diverse enough as a set and/or sufficiently different from each other based on one or more business rules. The buyer 202 then provides (i) travel party information and (ii) payer information for the two or more travel itineraries and the two or more destinations. The buyer 202 agrees (i) to buy a subset of a) the two or more travel itineraries and b) two or more destinations in the travel online shopping cart, and (ii) to a penalty for subsequently canceling the booking. The product selection server 206 selects at least one destination from the two or more destinations in the travel online shopping cart based on one or more predefined rules specified by the provider 208. The provider 208 selects at least one destination from the two or more destinations in the travel online shopping cart based on one or more predefined rules specified by the provider to obtain a selected destination, in one example embodiment. The provider 208 may be an airline service provider, a hotel room service provider, a car rental service provider, or any other travel-related service provider who has a business relationship with the product selection server 206. Once the selected destination is provided to the buyer, the buyer then selects at least one travel itinerary from the two or more travel itineraries such that the at least one travel itinerary corresponds to the selected destination. The product selection server 206 then performs a monetary transaction to complete the booking for the at least one travel itinerary and the selected destination. The product selection server 206 then communicates that the at least one travel itinerary and the selected destination has been purchased by the buyer 202.

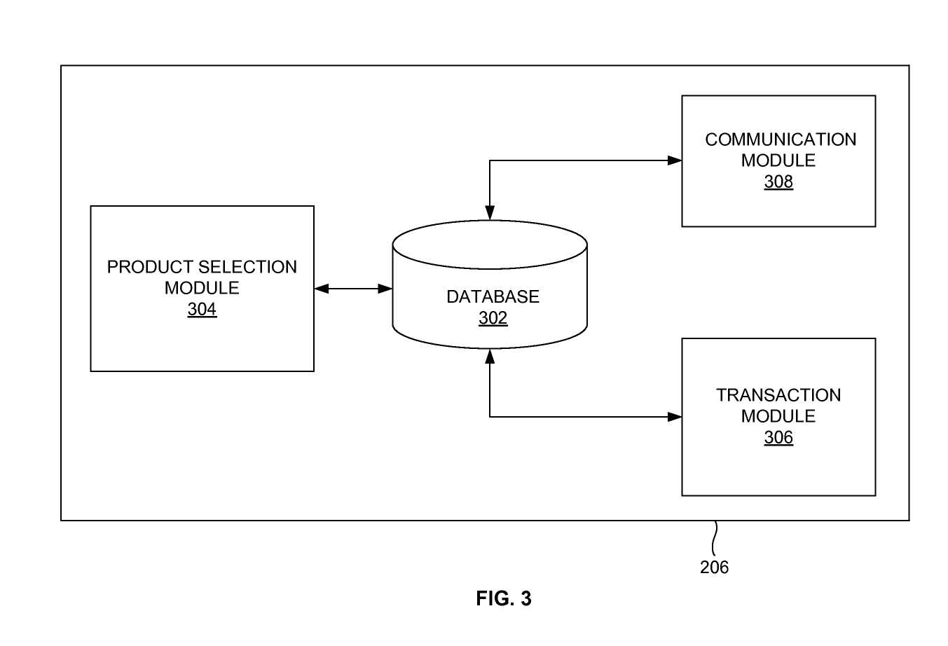

FIG. 3 illustrates an exploded view of the product selection server 206 of FIG. 2 according to an embodiment herein. The product selection server 206 includes a database 302, a product selection module 304, a transaction module 306, and a communication module 308. The database 302 stores details of the travel online shopping cart as received from the buyer 202. The details include two or more travel itineraries, and two or more destinations added by the buyer 202. Each of the two or more travel itineraries in the travel online shopping cart may have a different destination. Each of the different destinations may serve a different regional market. A subset of the two or more travel itineraries may overlap. An amount of the overlap may be subject to a rule set by the provider 208. Each of the two or more travel itineraries may have the same travel date, in one example embodiment. Each of the two or more travel itineraries may have significantly different spans of dates, in another example embodiment. Further, each of the travel itineraries may have the same destination. The travel online shopping cart may include exactly two travel itineraries, in one example embodiment. The buyer 202 may determine a validity of the travel online shopping cart based on the set of business rules. The database may further store details associated with (i) one or more service providers, (ii) one or more buyers, and (iii) one or more non-refundable products. The buyer provides at least (i) travel party information and (ii) payer information for the two or more travel itineraries and two or more destinations.

The product selection server 206 may dynamically adjust and display a list of travel products (e.g., itineraries and destinations) to the buyer 202 based on a progressive population or deletion of the two or more travel itineraries from the travel online shopping cart. The list of travel products is dynamically adjusted based on at least one adjustment criterion. The at least one adjustment criterion may be a distance between destination airports. The list of travel products is dynamically adjusted based on a set of airlines marketing or operating flights already in the travel online shopping cart as compared to (i) marketing candidate flights or (ii) operating candidate flights, etc.

The product selection server 206 obtains an agreement from the buyer (i) to buy a subset of a) the two or more travel itineraries and b) the two or more destinations in the travel online shopping cart, and (ii) to a penalty for subsequently canceling the booking. The buyer 202 may also indicate an affinity (e.g., a relative affinity or an absolute affinity) for each of two or more travel itineraries and two or more destinations in the travel online shopping cart. Upon obtaining the agreement from the buyer 202, the product selection module 304 selects at least one destination from the two or more destinations in the travel online shopping cart to obtain a selected destination based on one or more predefined rules specified by the provider 208.

The provider selects the at least one destination based on (i) a revenue optimization algorithm, (ii) an inventory management algorithm, (iii) an increasing consumer surplus algorithm, or (iv) combinations thereof to solve a multi-objective optimization problem. Once the product selection module 304 notifies the buyer of the selected destination, the buyer 202 then selects at least one travel itinerary based on the selected destination. The at least one travel itinerary may be air travel that includes a package that further includes flight details, an air travel ticket, a hotel room, a car rental, or any other travel-related products. The at least one travel itinerary is selected by the buyer 202 based on a voucher or a promotional code provided by the provider 208 when the selected destination is obtained.

The transaction module 306 performs a monetary transaction to complete the booking for the at least one travel itinerary and the selected destination. The monetary transaction is performed based on the affinity indicated by the buyer 202. The monetary transaction for the selected destination is (i) not exchangeable, (ii) not refundable, (iii) not transferable, or (iv) not reimbursable, in full or in part. Further, the monetary transaction may be performed to complete the booking for the at least one travel itinerary and the selected destination by (i) obtaining a deposit in part (or in full) from the buyer 202, and/or (ii) obtaining a balance upon selection by the buyer 202 of the at least one itinerary. The balance may be calculated based on an actual itinerary chosen. The communication module 308 communicates that the at least one travel itinerary and the selected destination has been purchased by the buyer 202. The travel party may include one or more travelers. Each of the one or more travelers is booked into the at least one travel itinerary and the selected destination.

The communication module 308 may further communicate details associated with the at least one travel itinerary and the selected destination. The communication module 308 may further communicate one or more ancillary services related to the at least one travel itinerary and the selected destination.

The buyer 202 may select an airline ticket from a first origin to a first destination (e.g., from Chicago to Paris). Further, the buyer 202 may select another airline ticket from the same first origin to a second destination (e.g., from Chicago to London). During the selection of the tickets, the product selection server 206 may display a flight selection service, a ticketing service, and/or a seat map service to the buyer 202. The buyer 202 may be provided with an interface to examine and place some itineraries into the shopping cart. Based on the one or more predefined selection algorithms, the product selection server 206 selects at least one of a destination (e.g., either Paris or London), using the product selection module 304. For example, where both flights are served by a same airline, by applying the revenue optimization algorithm, the airline may prefer to sell the higher-yielding tickets first to the buyer 202.

Similarly, if the buyer 202 indicates he/she is indifferent to the choice between a flight from New York to London and a flight from New York to Paris, the provider 208 may apply that inventory management algorithm to choose and sell a flight from New York to London if it has a greater inventory and seat availability for that flight, and preserve the flight to Paris for sale at a later point. The inventory may be received from a global distribution system (GDS) or a reservation system, or is pre-allocated to the provider 208.

Similarly, the provider 208 may apply the customer surplus management algorithm. In such scenarios, the buyer 202 may be allowed to indicate his/her greater preference for one product over another product, subject to the restrictions imposed by the service provider. This can be accomplished by the buyer 202 by using a slider or any another user interface method to indicate his/her preference for one flight over another (e.g., 65% probability of selecting Paris vs. 35% probability of selecting London). Further, the ability to influence the selection may be used as part of a reward program, where the buyer 202 is rewarded with an additional influence on the selection process for engaging in desirable behaviors, such as repeated booking; providing certain information about the buyer 202 or the trip; linking other travel accounts; logging in with social data, thus allowing the service provider to access user's account information, etc.

Similarly, the supplier management algorithm may be applied when the product selection server 206 assigns a greater probability of selection to flights provided by certain airlines/service providers. The provider 208 may quote a special fare/price for (i) the two or more itineraries and/or (ii) two or more destinations. This fare can be lower than the open market fare for the corresponding itinerary for the two or more itineraries, in one example embodiment. The fare for the at least one travel itinerary and the selected destination may be lower than an open market fare that corresponds to the at least one travel itinerary and the selected destination.

In some embodiments of the invention, the system may assign all airports to a particular metropolitan area. To prevent arbitrage, the system may also prevent the buyer 202 from selecting an airline ticket from a first origin to a first destination airport (e.g., JFK International Airport) and another airline ticket from the same first origin to a second destination airport that serves the same metropolitan area as the first destination airport (e.g., LaGuardia Airport). To assign airports to metropolitan areas, the system may first construct a list of all airports sorted by popularity in descending order where the system bases popularity on origin and destination flight volume data. The system then iterates through the list, starting with the most popular airport. For each airport A1 in the list, the system calculates the distance from A1 to all previously visited airports in the list one by one. If no previously visited airports are within R miles of A1, the system creates a new metropolitan area centered on A1. Otherwise, if the system discovers an airport A2 that is within R miles of A1, the system adds Al to the metropolitan area that is centered on A2. By iterating through the entire list, the system generates a number of metropolitan areas, each of which contains at least one airport.

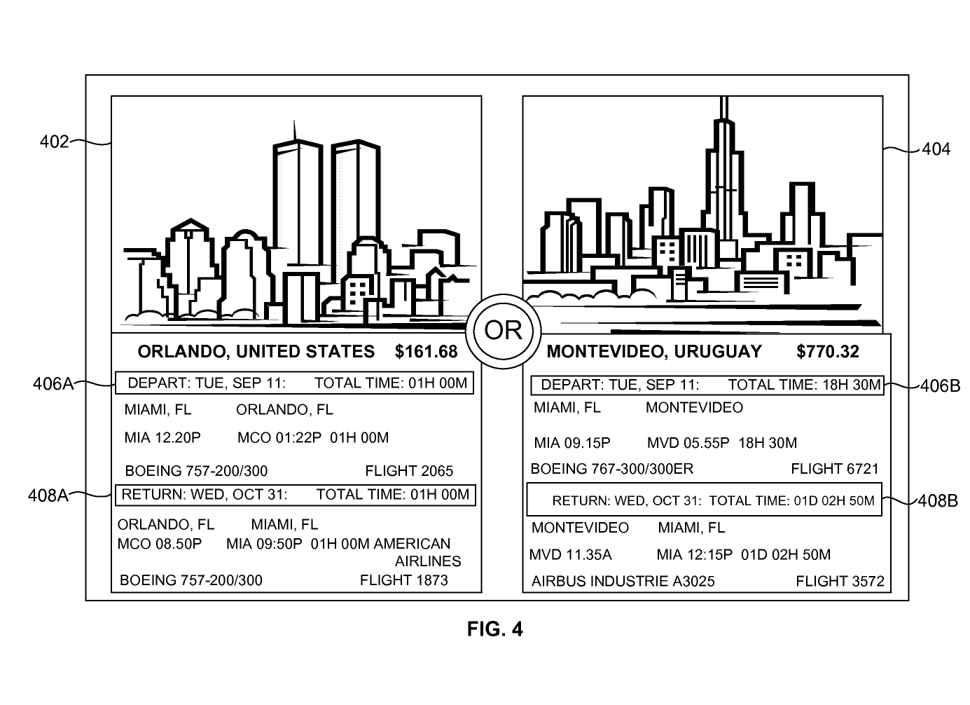

FIG. 4 is a user interface view of the product selection server 206 of FIG. 2 illustrating a comparison of two travel itineraries according to an embodiment herein. The comparison of the two travel itineraries indicates two different destinations 402 and 404, in one example embodiment. One or more rules may be displayed to the buyer 202. The rules are provided to the buyer 202 to ensure the validity of the selected shopping cart. The buyer 202 commits to purchase (by agreeing to operational and legal guidelines) at least one of the two destinations. The buyer 202 selects the two different destinations 402 and 404 where he/she is willing to travel. The first destination is Orlando, Fla., United States, in one example embodiment. The second destination is Montevideo, Uruguay, in another example embodiment. The first destination 402 includes a departure field 406A that indicates departure time and duration of the trip, and a return field 408A that includes the same information for the return trip of the buyer 202. The travel itinerary for the first destination may further include flight selected fields that indicate which airline and flight the buyer 202 has chosen (e.g., American Airlines, departure flight no. 2065 and return flight no. 1873). Similarly, the second destination 404 includes a departure field 406B that indicates departure time and duration of the trip, and a return field 408B that includes the same information for the return trip of the buyer 202 from the second destination. The travel itinerary for the second destination may further include flight selected fields that indicate which airline and flight the buyer 202 has chosen (e.g., LAN Airlines, departure flight no. 6721 and return flight no. 3572). A subset of two or more travel itineraries as shown in FIG. 4 may include air travel details that are opaque. A portion of the itinerary details of the subset are hidden for a substantial period of time when displayed to the buyer 202. The air travel details may include (i) operating or marketing carrier details, and/or (ii) departure dates, etc.

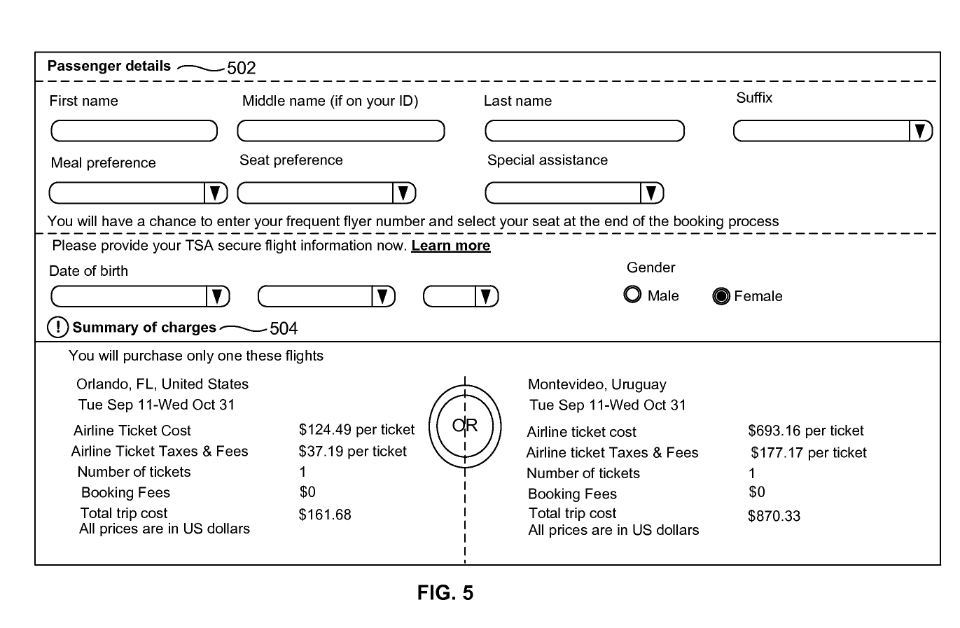

FIG. 5 is a user interface view of the product selection server 206 of FIG. 2 illustrating a method of processing, from the buyer 202, travel party information and payer information for the two or more travel itineraries and the two or more destinations to perform a monetary transaction to complete the booking for at least one travel itinerary and the selected destination according to an embodiment herein. The user interface view includes a passenger details field 502 and a summary of charges field 504. The passenger details field 502 allows the buyer 202 to enter his/her personal information, such as first name, middle name, last name, suffix, meal preference, seat preference, special assistance requirements, date of birth, and/or gender, etc. The summary of charges field 504 displays an airline ticket cost, number of tickets purchased, and a total trip cost, etc. for each of the two destinations. Of the two flights, the buyer 202 will purchase only one.

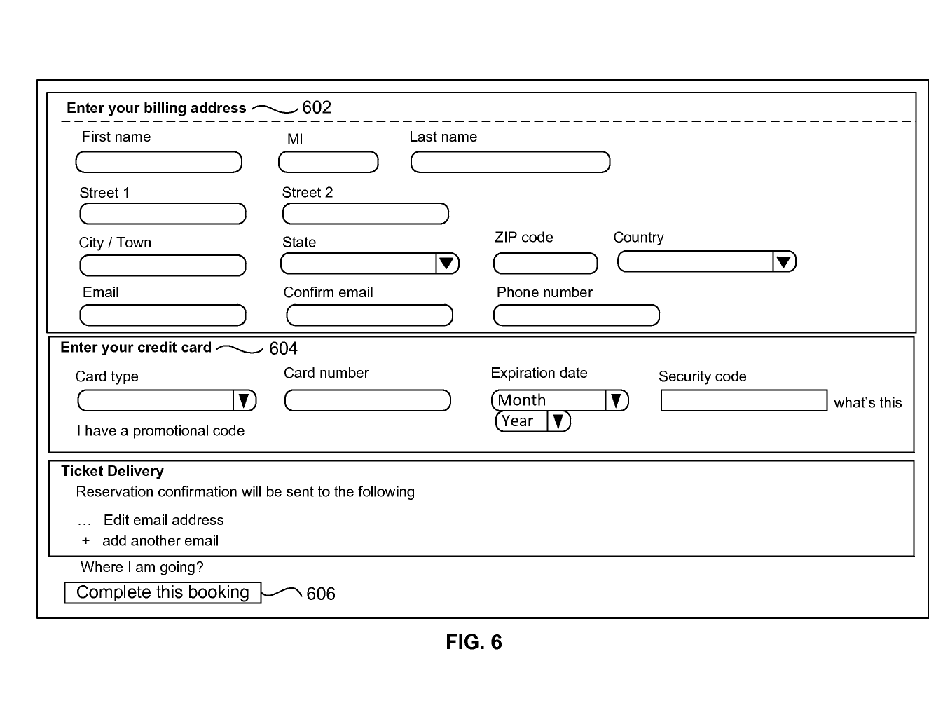

FIG. 6 is a user interface view of the product selection server 206 of FIG. 2 illustrating a method of completing a booking or transaction for one of the two destinations according to an embodiment herein. One of the two destinations is the selected destination. The user interface view includes an “enter your billing address” field 602, an “enter your credit card” field 604, and a “complete this booking” button 606. The “enter your billing address” field 602 allows the buyer 202 to enter his/her billing address (e.g., first name, middle initial, last name, street, city/town, ZIP code, country, email, phone number, etc.) The “enter your credit card” field 604 allows the buyer 202 to enter credit card information (e.g., card type, card number, expiration date, and security code) for completing the transaction. The product selection server 206 may also enable the buyer 202 to make payments toward completing the transaction by using any of the payment methods. The buyer 202 completes the transaction by clicking on the “complete this booking” button 606. The payment process or the selection process of the products may be hosted on a third-party server, and the buyer 202 may be redirected to the third-party server to complete the transaction.

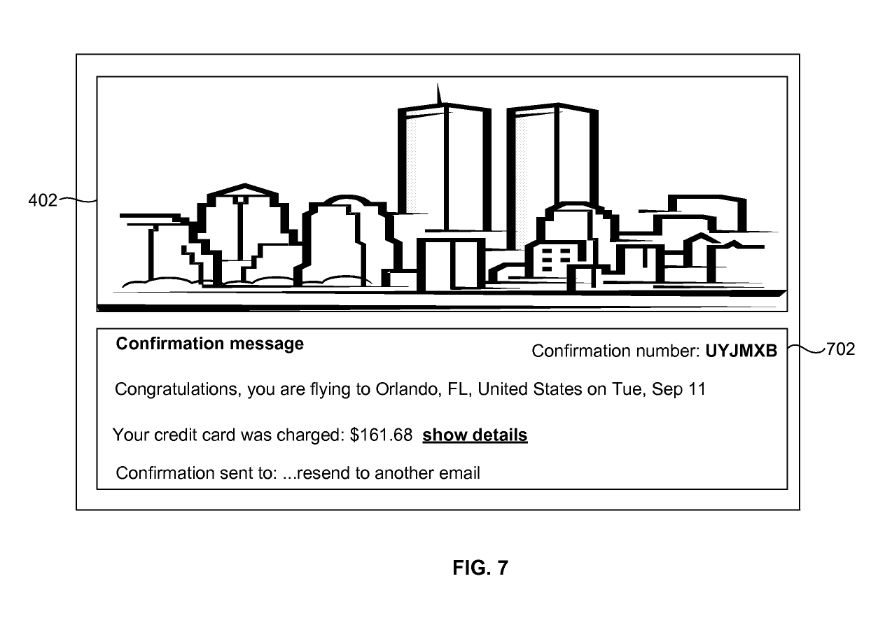

Note that FIG. 7 is a user interface view of the product selection server 206 of FIG. 2 illustrating a method of sending a confirmation message that indicates that the at least one travel itinerary and the selected destination has been purchased by the buyer 202 according to an embodiment herein. Upon receiving a click on the “complete this booking” button 606, the product selection module 304 selects one of the two destinations based on the one or more predefined selection algorithms to obtain the selected destination. The product selection server 206 selects Orlando, Fla., United States as the place of travel and displays a confirmation message in a confirmation field 702. The confirmation message may include a confirmation number (e.g., UYJMXB) and destination details (e.g., Congratulations, you are flying to Orlando, Fla., United States, on Tue, September 11, your credit card was charged: $161.68, confirmation sent to: to another email). The buyer 202 may click on the “show details” link to view additional details related to this transaction. Details of the at least one travel itinerary and the selected destination may be displayed to the buyer 202 only after performing the monetary transaction.

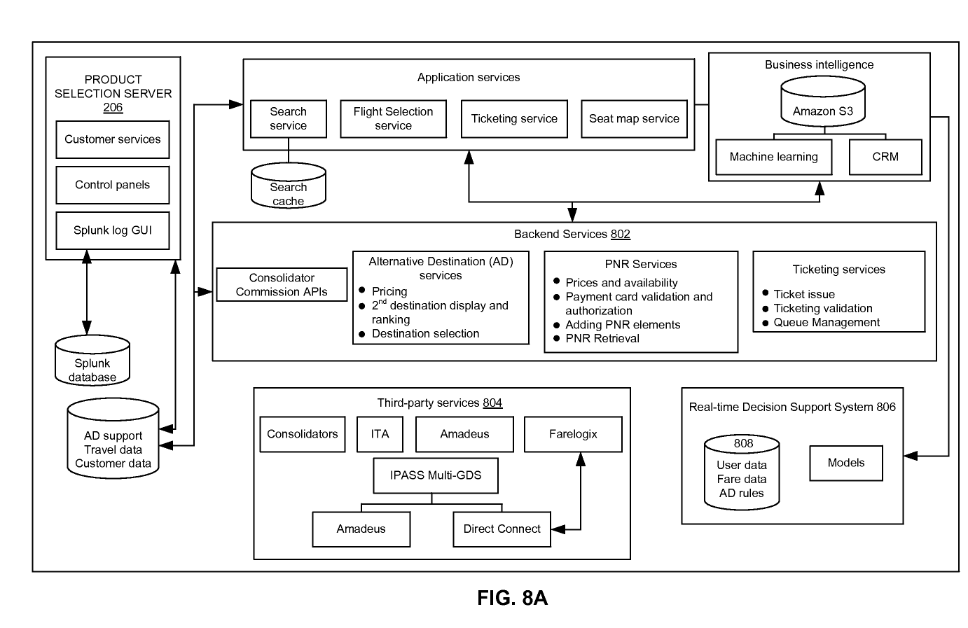

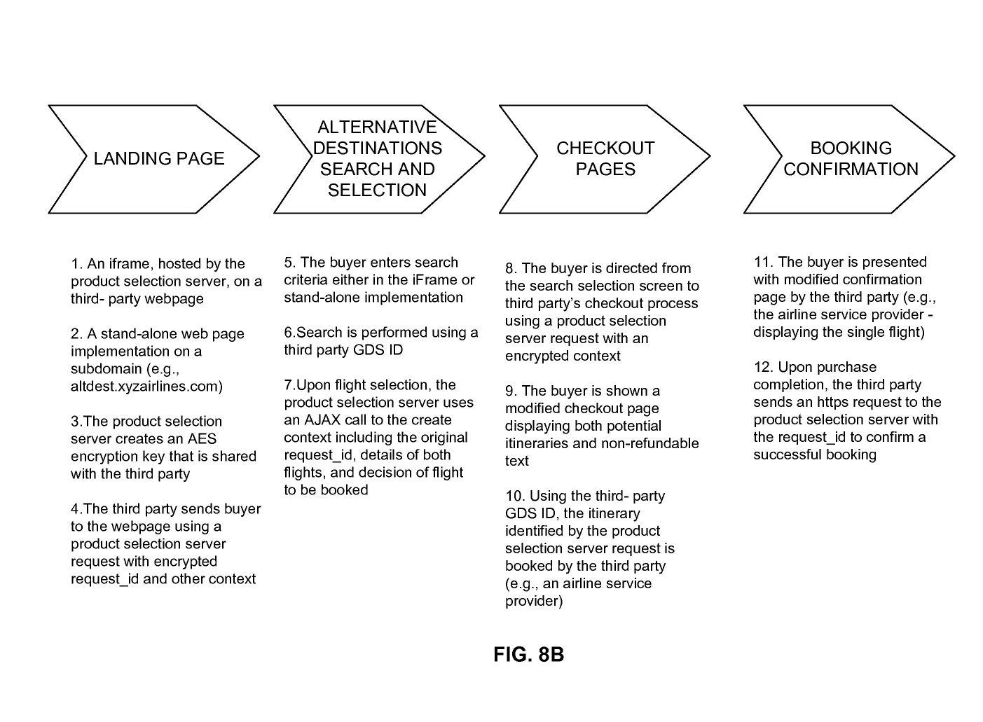

FIG. 8A is a block diagram illustrating an integration of the product selection server 206 of FIG. 2 within a product portal of an airline service provider according to an embodiment herein. The block diagram of the product portal associated with the airline service provider includes the product selection server 206, a backend services block 802, a third-party services block 804, and a real-time decision support system 806. The block diagram may further include a business intelligence block that includes a database (e.g., Amazon simple storage service (Amazon S3)), a machine learning block, and a customer relationship management (CRM) block.

The product selection server 206 includes customer services, control panels, and a Splunk log graphical user interface (GUI) that includes a Splunk database. The backend services block 802 may include consolidator commission application programming interfaces (APIs), alternative destinations services, passenger name record (PNR) services, and ticketing services. The alternative destinations services block includes details associated with pricing, 2nd destination display and ranking, and destination selection for one or more products (e.g., a travel-related product).

The PNR services may include details such as prices and availability of the one or more products, payment card validation and authorization services, adding PNR elements (e.g., passenger name, address, etc.), and PNR retrieval for further processing. The ticketing services may include ticket issue, ticketing validation, and queue management. The database 302 may include alternative destinations support services, travel data, and customer data associated with the one or more products. The third-party services block 804 may include details of one or more third-party service providers (e.g., consolidators, ITA, Amadeus, Farelogix, etc.) who provide other travel-related products. The database 302 of the product selection server 206 may also include alternative destination support service, travel data, and customer data. The real-time decision support system 806 includes a database 808.

The database 808 stores information associated with (i) one or more users, (ii) fare data or pricing of the one or more products, and (iii) alternative destinations rules, etc. The real-time decision support system 806 provides real-time decision support to the one or more service providers for making one or more decisions for alternative destinations selection. The decisions may be based on the information associated with (i) one or more users (e.g., user data), (ii) pricing of the one or more products (e.g., fare data), and (iii) alternative destinations (AD) rules, etc.

As described above, based on the one or more predefined selection algorithms, a third-party service provider (e.g., the airline service provider) may select at least one of a destination (e.g., either Paris or London) using the product selection module 304. For example, where both flights in the selected non-refundable travel-related products are served by a same airline and further by applying the revenue optimization algorithm, the airline may prefer to sell the higher-yielding tickets first to the buyer 202.

Similarly, if the buyer 202 indicates he/she is indifferent to the choice between a flight from New York to London and a flight from New York to Paris, the airline service provider may apply that inventory management algorithm to choose and sell a flight from New York to London if it has a greater inventory and seat availability for that flight, and preserve the flight to Paris for sale at a later point.

Similarly, the third-party service provider may apply the customer surplus management algorithm. In such scenarios, the buyer 202 may be allowed to indicate his/her greater preference for one product over another product, subject to the restrictions imposed by the service provider. This can be accomplished by the buyer 202 by using a slider or any another user interface method to indicate his/her preference for one flight over another (e.g., 65% probability of selecting Paris vs. 35% probability of selecting London). Further, the ability to influence the selection may be used as part of a reward program, where the buyer 202 is rewarded with an additional influence on the selection process for engaging in desirable behaviors, such as repeated booking; providing certain information about the buyer 202 or the trip; linking other travel accounts; logging in with social data, thus allowing the service provider to access the user's account information, etc.

Similarly, the supplier management algorithm may be applied when the product selection server 206 assigns a greater probability of selection to flights provided by certain airlines/service providers. The airline/service provider may quote a special fare/price for one or more itineraries. This fare can be lower than the fare for the corresponding itinerary being sold on an open market.

Once the products are selected by the product selection module 304 based on the one or more predefined algorithms, and an approval from the buyer 202 to execute, the transaction module 306 performs the transaction for the selected destination by obtaining required transaction details from the buyer 202. The buyer 202 is then charged for the selected product.

The airline service provider may apply the same predefined selection algorithms to select one of the two destinations, in one example embodiment. The airline service provider may create a different set of selection algorithms (or alternative destinations rules) to select one of the two destinations, in another example embodiment herein. The different set of selection algorithms may be created based on inventory, pricing, availability, ranking, or any other such criterion. The airline service provider may then notify the buyer 202 which product/destination is selected. The selection of at least one of the products/destinations may differ when the product selection server 206 is integrated within a product portal of the airline service provider, in one embodiment. For example, the selection of at least one product as performed by the product selection server 206 when hosted by another service provider may not be similar when hosted by the airline service provider.

FIG. 8B illustrates a flow diagram of completing a booking for a selected destination on a third-party web page according to an embodiment herein. A booking page (e.g., a landing page, or an iframe) is hosted by the product selection server 206 on a web page associated with a third party (e.g., an airline web page, or a third-party web page). The third-party web page is a page on an airline website, in one example embodiment. The booking page may include standard header, footer, and navigational menus, in one example embodiment. The product selection server 206 creates HMAC and encryption keys that the airline server and the product selection server 206 share. The airline creates a link(s) pointing to the Alternative Destinations landing page. For a stand-alone implementation (as opposed to within an iframe) the airline creates (i) a subdomain, such as altdest.xyzairline.com, and (ii) a Global Distribution System (GDS) office id for Alternative Destinations. In one example embodiment, the subdomain is altdest.westjet.com. The airline loads fares for this office id or provides “paper contract” fares to be loaded into the GDS using a fare loading module, such as Amadeus FareXpert. This enables the product selection server 206 to use the existing code base, which further allows the airline to book a flight using the same office id as the one used for searching. The airline creates the checkout flow for Alternative

### Destinations Customers.

The product selection server 206 creates an authenticating application key for the airline to send tracking info back to the product selection server 206. The third party (e.g., the airline) sends the buyer 202 to the web page using a request (e.g., a product selection server request) with an encrypted request_id and other context.

When the buyer 202 enters search criteria on the product portal of the airline service provider (e.g., the third party), the search is performed by the product portal of the airline service provider using the GDS office ID. For example, when the buyer 202 clicks on an Alternative Destinations link on the airline page, a server associated with the airline generates the request_id and sends the buyer to the landing page using a request (e.g., a product selection server request) with an encrypted context (e.g., request_id, together with any additional user context that the airline enables the product selection server 206 to use, such as the user's first name, for example, {‘request_id’: 17, ‘user_context’: {‘first_name’: ‘Joe’}}, and the HMAC code of the encrypted payload).

During the search, the buyer 202 may be presented with one or more application services such as a flight selection service, ticketing service, and/or a seat map service, etc. Upon selection of one or more products (e.g., selecting 2 flights) by the user, the product selection server 206 uses a call function (e.g., an AJAX call) to create a context including an original request ID, details of the flights associated with the one or more products), and decision of the flight to be booked. For example, upon clicking “Next” of the search result page, the page makes an AJAX call to the product selection server 206 to generate the context of the buyer request that may include request_id, flight1_details, and flight2_details for the flight that the buyer will get (1 or 2).

The buyer 202 is then redirected from the selection process page to a checkout page by the product selection server 206 using the original request ID with the encrypted context. For example, $.ajax ({url:‘/put_user_context_together’, type: ‘POST’, data: {flight1_details:$.toJSON(flight1.get(‘info’)), flight2_details: $.toJSON (flight2.get(‘info’)),}, success: function(response){window.location.href=‘www.xyzairline.com/altdest_checkout?context=’+response.context}}). The buyer 202 completes the process using the airline's AD checkout flow. The buyer is shown both flights (retrieved from the passed context), the legal text asking the user to agree to either itinerary option, etc. A modified checkout page may be displayed to the buyer 202 that includes potential itineraries and ticket rule information (such as the ticket being non-refundable, non-exchangeable, etc.). The product portal of the airline service provider then books an appropriate flight based on an itinerary identified by the original request ID, and a global distribution system ID associated with the airline service provider (e.g., WestJet). The airline service provider then displays a confirmation page that indicates purchase (completing a monetary transaction) of one flight out of the two flights by the buyer 202. Upon completing the purchase, the airline service provider (e.g., WestJet) transmits an https request to the product selection server 206 with the request_id and an authenticating key to confirm a successful booking of the flight (e.g., an airline ticket). This allows the product selection server 206 to track the booking

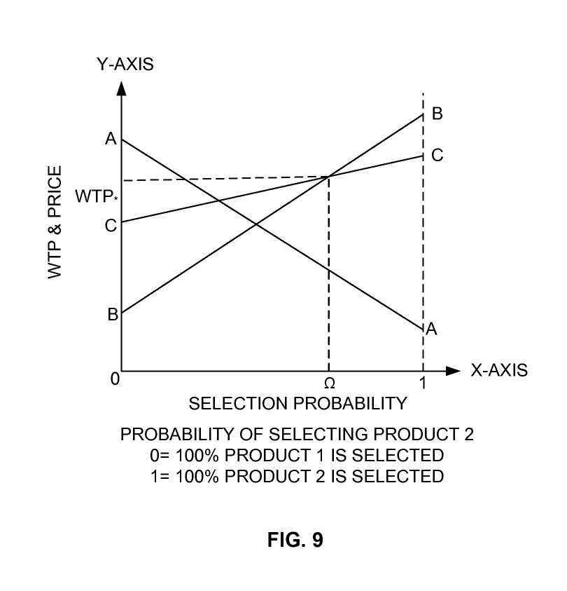

FIG. 9 is a graphical representation illustrating a revenue-optimal selection probability of a product from the pool of substitutable product options according to an embodiment herein. The graphical representation is plotted with reference to willingness to pay (WTP) and price along the y-axis, and selection probability along the x-axis. For example, assume all the prospective consumers in the market are split evenly among three types denoted A, B, and C. Revenue-maximizing provider 208 offers two products: Product 1 and Product 2. The three lines represent a willingness to pay (WTP) of each consumer for an uncertain product on the y-axis as a function of selection probability of product 2 on the x-axis (SP2). At SP2 equals zero, the WTP of A, B, and C is equal to their WTP for Product 1; at SP2 equals 1, the WTP of A, B, and C is equal to their WTP for Product 2 according to embodiments herein. Under these assumptions, SP2=Ω≠0.75 can be seen to maximize the revenue of provider 208.

The revenue-maximizing provider 208 may set the price of component products 1 and 2 to values WTP A1-2Δ and WTP B2-2Δ respectively, and set the price of the uncertain product to WTP Ω-Δ, where Δ is a small positive number. At these prices, both product 2 and the uncertain product have negative surpluses for this customer, while product 1 offers a slightly positive surplus of 2Δ. Similarly, customer B will buy Product 2, capturing the surplus of 2Δ, while customer C will buy the uncertain product, capturing the surplus of Δ. In an embodiment the airline is able to capture all revenue by making sales of products 1 and 2 directly to price-insensitive customers A and B, and selling the uncertain product to price-sensitive customer C.

The embodiments herein can take the form of an embodiment rendered entirely in software, or an embodiment including both hardware and software elements. The embodiments that are implemented in software include, but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including, but not limited to, keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

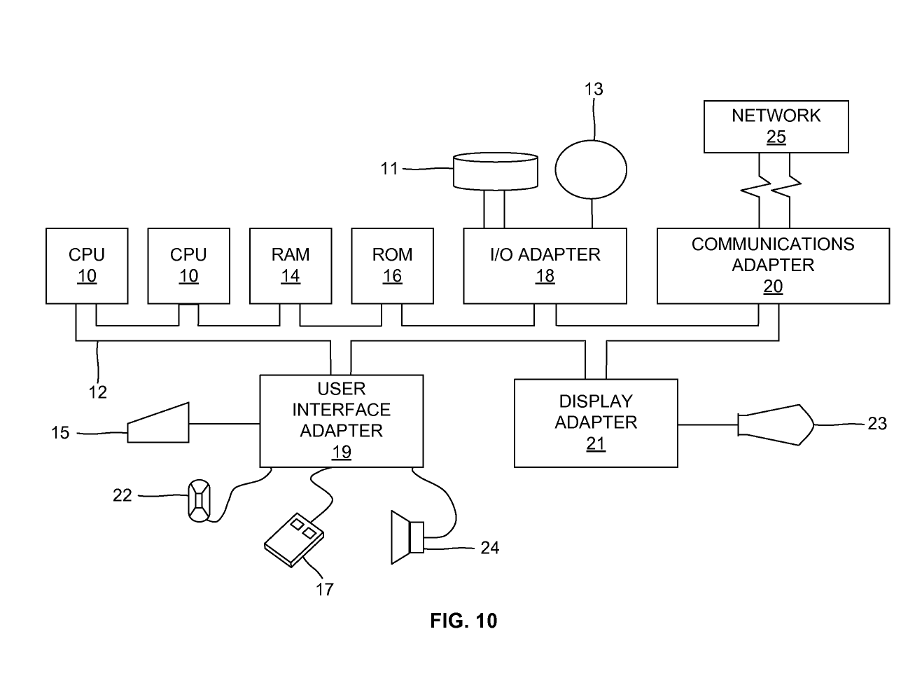

A representative hardware environment for practicing the embodiments herein is depicted in FIG. 10. This schematic illustrates a hardware configuration of an information handling/computer system in accordance with the embodiments herein. The system comprises at least one processor or central processing unit (CPU) 10. The CPUs 10 are interconnected via system bus 12 to various devices, such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the instructions on the program storage devices and follow these instructions to execute the methodology of the embodiments herein.

The system further includes a user interface adapter 19 that connects a keyboard 15, mouse 17, microphone 22, speaker 24, and/or other user interface devices, such as a touch screen device (not shown) or a remote control to the bus 12, to gather user input. Additionally, a communications adapter 20 connects the bus 12 to a data processing network 25, and a display adapter 21 connects the bus 12 to a display device 23 which may be embodied as an output device, such as a monitor, printer, or transmitter, for example.

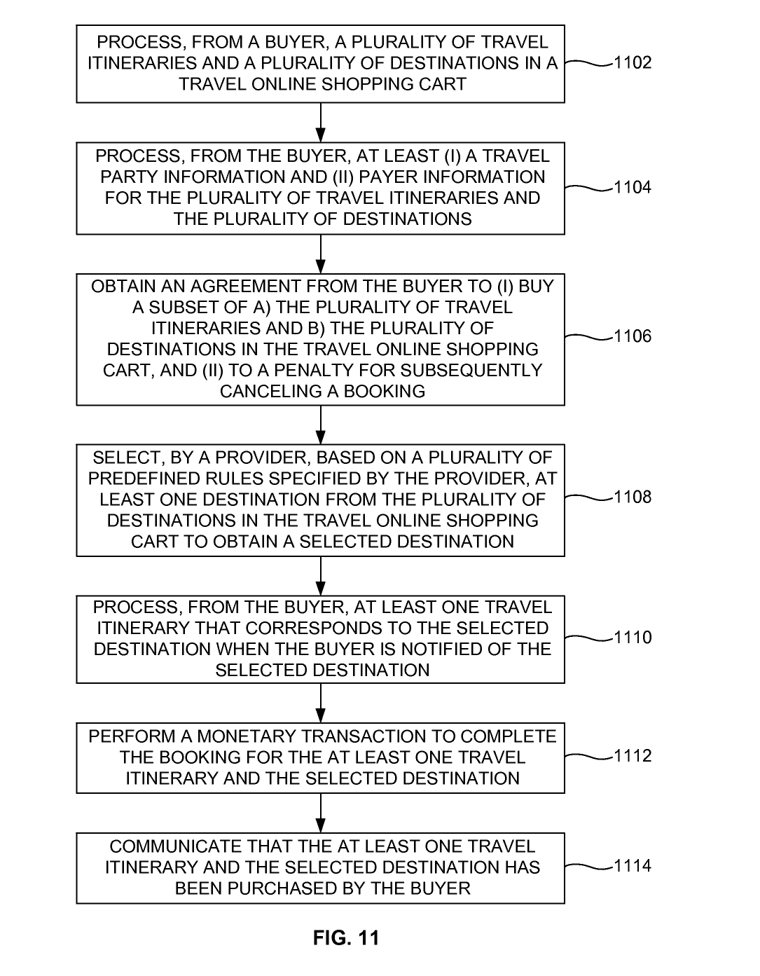

FIG. 11 is a flow diagram illustrating a method of completing a booking based on two or more travel itineraries added to a travel online shopping cart according to an embodiment herein. In step 1102, two or more travel itineraries and two or more destinations in the travel online shopping cart are processed from the buyer. The two or more travel itineraries and the two or more destinations are diverse enough as a set based on a plurality of business rules. In step 1104, at least (i) travel party information and (ii) payer information for two or more travel itineraries and two or more destinations are processed from the buyer. In step 1106, an agreement is obtained from the buyer (i) to buy a subset of a) the two or more travel itineraries and b) the two or more destinations in the travel online shopping cart, and (ii) to a penalty for subsequently canceling the booking.

In step 1108, at least one destination from the two or more destinations in the travel online shopping cart is selected by a provider to obtain a selected destination. The provider selects the at least one destination based on one or more predefined rules specified by the provider. In step 1110, at least one travel itinerary from two or more itineraries is processed from the buyer when the buyer is notified of the selected destination. The provider 208 may select a subset of the two or more travel itineraries in the travel online shopping cart to sell to the buyer 202. The provider 208 may provide a mechanism to the buyer to select one or more travel itineraries if the selected destination was chosen from the travel online shopping cart. The buyer selects the at least one travel itinerary from the subset of the two or more travel itineraries only when the selected destination is chosen from the travel online shopping cart. The at least one travel itinerary corresponds to the selected destination. In step 1112, a monetary transaction is performed to complete the booking for the at least one travel itinerary and the selected destination. In step 1114, the at least one travel itinerary and the selected destination that has been purchased by the buyer is communicated.

The travel party information may include one or more travelers. Each of the one or more travelers is booked into the at least one travel itinerary and the selected destination. A fare for the at least one travel itinerary and the selected destination may be lower than an open market fare that corresponds to the at least one travel itinerary and the selected destination. A validity of the travel online shopping cart may be determined by the buyer based on the set of business rules. The at least one travel itinerary is an air travel itinerary that includes a package. The package may include an air travel ticket, a hotel room, a car rental, or any other travel-related products.

The travel online shopping cart may include exactly two travel itineraries. Each of the two or more travel itineraries in the travel online shopping cart may have a different destination. Each of the different destinations may serve a different regional market. A subset of the two or more travel itineraries may overlap. An amount of the overlap may be subject to a rule set by the provider. Each of the two or more travel itineraries may have the same travel date. The two or more travel itineraries may have significantly different spans of dates. Each of the two or more travel itineraries in the travel online shopping cart may have the same destination.

A subset of the two or more travel itineraries may include air travel details that are opaque. A portion of itinerary details of the subset may be hidden for a substantial period of time when displayed to the buyer. The air travel details may include (i) operating or marketing carrier details, and (ii) departure dates. Details of the at least one travel itinerary and the selected destination may be displayed to the buyer only after performing the monetary transaction. A list of travel products may be dynamically adjusted and displayed to the buyer based on a progressive population or deletion of two or more travel itineraries from the travel online shopping cart. The list of travel products may be dynamically adjusted based on at least one adjustment criterion. The at least one adjustment criterion may be a distance between destination airports.

The list of travel products may be dynamically adjusted based on a set of airlines marketing or operating flights already in the travel online shopping cart as compared to (i) marketing candidate flights or (ii) operating candidate flights. The provider may select the at least one destination based on (i) a revenue optimization algorithm, (ii) an inventory management algorithm, (iii) an increasing consumer surplus algorithm, or (iv) combinations thereof to solve a multi-objective optimization problem. The buyer may indicate an affinity for each of the two or more travel itineraries and the two or more destinations in the travel online shopping cart. The at least one itinerary and the selected destination may be selected based on the affinity indicated by the buyer. The monetary transaction for the selected destination is (i) not exchangeable, (ii) not refundable, (iii) not transferable, or (iv) not reimbursable, in full or in part. The at least one travel itinerary is selected by the buyer based on a voucher or a promotional code provided by the provider when the selected destination is obtained. A deposit may be obtained to perform the monetary transaction. A balance may be obtained from the buyer, upon the buyer's selection of the at least one itinerary. The balance is calculated based on an actual itinerary chosen.

The product selection server 206 allows one or more providers to identify and segment customers based on the strength of their preferences for a specific product (e.g., a specific itinerary and/or a specific destination). The product selection server 206 selects at least one of the two products based on one or more predefined selection algorithms (or one or more predefined rules which are specified by the one or more providers). This ensures that the products (e.g., flights) with different desirability to the consumer fill up more uniformly. The product selection server 206 further improves price discrimination and enhances profits, or yields. The product selection server 206 further provides flexibility to the providers to offer ancillary products/services such as hotel rooms, car rentals, and any other products to customers who have purchased a travel-related product (e.g., an airline ticket).

The method described above helps the airlines and/or any other service providers preserve their current high-WTP buyers while, at the same time selling additional seats (or other products). The customer/buyer also benefits from a) having the certainty of selecting each of specific itineraries that are added to a shopping cart, and b) having an immediate confirmation of the purchase and a guaranteed seat upon completion of the purchase. The above method can also be implemented for selling and buying other products that can be selected based on uncertainty, and is not limited to airline travel products (e.g., a travel industry or a hospitality industry).

The foregoing description of the specific embodiments will so fully reveal the general nature of the embodiments herein that others can, by applying current knowledge, readily modify and/or adapt for various applications such specific embodiments without departing from the generic concept and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### Conclusion

The disclosed embodiments relate to a system that facilitates the purchase of a travel itinerary subject to destination uncertainty. During operation, the system receives a plurality of selected itineraries from a buyer, wherein the plurality of selected itineraries includes a first itinerary associated with a first destination and a second itinerary associated with a second destination. Next, upon receiving an agreement from the buyer to purchase an unspecified one of the plurality of selected itineraries, the system chooses one of the plurality of itineraries for the buyer, and completes the purchase of the chosen itinerary on behalf of the buyer.

In some embodiments, the first destination and the second destination are located in different regional markets and/or metropolitan areas.

In some embodiments, one or more of the selected itineraries has a total fare including discounts which is lower than a fare for a corresponding itinerary being sold on an open market.

In some embodiments, each of the plurality of selected itineraries specifies the following: a destination, a schedule, a fare, and a discount.

In some embodiments, each of the plurality of selected itineraries specifies travel party information for one or more travelers who all get booked on the same itineraries.

In some embodiments, each of the selected itineraries comprises a package which includes an air travel ticket and at least one of: a hotel room, a rental car, and another travel-related product.

In some embodiments, each of the selected itineraries provides one of the following modes of transportation: airplane, train, bus and ship.

In some embodiments, receiving the plurality of selected itineraries from the buyer involves providing a user interface. This user interface is configured to: display operational and legal guidelines for the purchase to the buyer; display a plurality of available travel itineraries to the buyer; allow the buyer to select the plurality of selected itineraries from the plurality of available travel itineraries; compare the plurality of selected itineraries against a set of provider rules; and allow the buyer to enter personal information, payer information and other information required to complete the purchase.

In some embodiments, the set of provider rules ensure that destinations associated with the selected itineraries meet one or more geographic diversity requirements.

In some embodiments, at least some of the plurality of selected itineraries overlap in time.

In some embodiments, all of the plurality of selected itineraries have the same travel dates.

In some embodiments, choosing one of the plurality of itineraries involves considering one or more of the following: revenue optimization; inventory management for the modes of travel associated with the plurality of itineraries; and buyer-inferred preferences.

In some embodiments, choosing one of the plurality of itineraries involves solving a multi-objective optimization problem.

In some embodiments, the agreement received from the buyer is associated with a penalty for cancelling the purchase transaction.

In some embodiments, the plurality of itineraries comprises exactly two itineraries.

In some embodiments, the system allows the buyer to indicate an affinity for one or more of the plurality of selected itineraries, wherein the indicated affinity is used while choosing one of the plurality of itineraries for the buyer.

The disclosed embodiments relate to another system that facilitates the purchase of a travel itinerary subject to destination uncertainty. This system receives a plurality of selected itineraries from a buyer, wherein the plurality of selected itineraries includes a first itinerary associated with a first destination and a second itinerary associated with a second destination. Next, upon receiving an agreement from the buyer to purchase an unspecified one of the plurality of selected itineraries, the system chooses two or more of the plurality of selected itineraries for the buyer. The system then allows the buyer to select a final itinerary from the two or more chosen itineraries, and completes the purchase of the final itinerary on behalf of the buyer.

In some embodiments, upon receiving the agreement from the buyer to purchase an unspecified one of the plurality of selected itineraries, the system collects a deposit from the buyer. Next, upon completing the purchase of the final itinerary on behalf of the buyer, the system collects a balance of the purchase price less the deposit for the final itinerary.

The disclosed embodiments relate to yet another system that facilitates the purchase of a travel itinerary subject to destination uncertainty. This system receives a plurality of destinations from a buyer. Next, upon receiving an agreement from the buyer to purchase an itinerary to an unspecified one of the plurality of destinations, the system: chooses a destination for the buyer; allows the buyer to select an itinerary to the chosen destination; and completes the purchase of the selected itinerary on behalf of the buyer.

The disclosed embodiments also relate to a system that facilitates a purchase of a travel itinerary subject to date uncertainty. This system is configured to receive a plurality of selected itineraries from a buyer, wherein the plurality of selected itineraries includes a first itinerary associated with a first set of dates and a second itinerary associated with a second set of dates. Next, upon receiving an agreement from the buyer to purchase an unspecified one of the plurality of selected itineraries, the system chooses one of the plurality of itineraries for the buyer and completes the purchase of the chosen itinerary on behalf of the buyer.

In some embodiments, the plurality of selected itineraries are all associated with the same destination.

In some embodiments, the plurality of selected itineraries have different departure dates.

In some embodiments, the plurality of selected itineraries are all non-overlapping in time.

In some embodiments, details for at least some of the plurality of selected itineraries are hidden from the buyer until after the purchase is complete. In some embodiments, the details are hidden until immediately after the purchase is complete. In other embodiments, the details are hidden until a predefined period of time after the purchase is complete.

What is claimed is:

1. A computer-implemented method for facilitating a purchase of a travel itinerary subject to date uncertainty, comprising:
receiving, at a computer system, a plurality of selected itineraries from a buyer, wherein the plurality of selected itineraries includes a first itinerary associated with a first set of dates and a second itinerary associated with a second set of dates; and
upon receiving, at the computer system, an agreement from the buyer to purchase an unspecified one of the plurality of selected itineraries,
choosing one of the plurality of itineraries for the buyer, and
completing the purchase of the chosen itinerary on behalf of the buyer.

2. The computer-implemented method of claim 1, wherein the plurality of selected itineraries are all associated with the same destination.

3. The computer-implemented method of claim 1, wherein the plurality of selected itineraries have different departure dates.

4. The computer-implemented method of claim 1, wherein the plurality of selected itineraries are all non-overlapping in time.

5. The computer-implemented method of claim 1, wherein at least some of the plurality of selected itineraries are opaque, in that at least some of the itinerary details are hidden from the buyer until after the purchase is complete.

6. The computer-implemented method of claim 5, wherein the details are hidden until immediately after the purchase is complete.

7. The computer-implemented method of claim 5, wherein the details are hidden until a predefined period of time after the purchase is complete.

8. The computer-implemented method of claim 1, wherein one or more of the selected itineraries has a total fare including discounts which is lower than a fare for a corresponding itinerary being sold on an open market.

9. The computer-implemented method of claim 1, wherein each of the plurality of selected itineraries specifies the following:
a destination;
a schedule;
a fare; and
a discount.

10. The computer-implemented method of claim 1, wherein each of the plurality of selected itineraries specifies travel party information for one or more travelers who all get booked on the same itineraries.

11. The computer-implemented method of claim 1, wherein each of the selected itineraries comprises a package which includes an air travel ticket and at least one of:
a hotel room;
a rental car; and
another travel-related product.

12. The computer-implemented method of claim 1, wherein each of the selected itineraries provides one of the following modes of transportation:
airplane;
train;
bus; and
ship.

13. The computer-implemented method of claim 1, wherein a provider of the chosen itinerary completes a monetary transaction associated with the purchase of the chosen itinerary.

14. The computer-implemented method of claim 13, wherein the provider redirects the buyer to a third-party website to complete the monetary transaction.

15. The computer-implemented method of claim 14, wherein the third-party website belongs to the inventory provider.

16. The computer-implemented method of claim 14, wherein the provider imbeds an iframe into the third-party website.

17. The computer-implemented method of claim 14, wherein the provider is given a web subdomain by the third party.

18. The computer-implemented method of claim 1,
wherein the plurality of selected itineraries are contained in a shopping cart; and
wherein an itinerary provider can dynamically adjust a list of products available to the buyer based on changes to the contents of the shopping cart.

19. The computer-implemented method of claim 18, wherein the dynamic adjustment is based on an adjustment criterion which accounts for distances between destination airports.

20. The computer-implemented method of claim 18, wherein the dynamic adjustment is based on an adjustment criterion which is based on a set of travel providers for itineraries in the shopping cart as compared to a set of travel providers for candidate itineraries.

21. The computer-implemented method of claim 1,
wherein the plurality of selected itineraries are contained in a shopping cart; and
wherein the buyer may edit the shopping cart by removing prior selections or by modifying a composition of a seller-created shopping cart.

22. A computer-implemented method for facilitating a purchase of a travel itinerary subject to date uncertainty, comprising:
receiving, at a computer system, a plurality of selected itineraries from a buyer, wherein the plurality of selected itineraries includes a first itinerary associated with a first date and a second itinerary associated with a second date; and
upon receiving, at the computer system, an agreement from the buyer to purchase an unspecified one of the plurality of selected itineraries;
choosing two or more of the plurality of selected itineraries for the buyer,
allowing the buyer to select a final itinerary from the two or more chosen itineraries, and
completing the purchase of the final itinerary on behalf of the buyer.

23. The computer-implemented method of claim 22,
wherein upon receiving the agreement from the buyer to purchase an unspecified one of the plurality of selected itineraries, the method further comprises collecting a deposit from the buyer; and
wherein completing the purchase of the final itinerary on behalf of the buyer involves collecting a balance of the purchase price less the deposit for the final itinerary.

24. A computer-implemented method for facilitating a purchase of a travel itinerary subject to destination uncertainty, comprising:
receiving, at a computer system, a plurality of dates from a buyer; and
upon receiving, at the computer system, an agreement from the buyer to purchase an itinerary for an unspecified one of the plurality of dates;
choosing a date for the buyer,
allowing the buyer to select an itinerary for the chosen date, and
completing the purchase of the selected itinerary on behalf of the buyer.

25. The computer-implemented method of claim 24,
wherein upon receiving the agreement from the buyer to purchase an itinerary for an unspecified one of the plurality of dates, the method further comprises collecting a deposit from the buyer; and
wherein completing the purchase of the selected itinerary on behalf of the buyer involves collecting a balance of the purchase price less the deposit for the selected itinerary.

26. A computer-readable storage medium storing instructions that when executed by a computer cause the computer to perform a method for facilitating a purchase of a travel itinerary subject to date uncertainty, the method comprising:
receiving, at a computer system, a plurality of selected itineraries from a buyer, wherein the plurality of selected itineraries includes a first itinerary associated with a first set of dates and a second itinerary associated with a second set of dates; and
upon receiving, at the computer system, an agreement from the buyer to purchase an unspecified one of the plurality of selected itineraries,
choosing one of the plurality of itineraries for the buyer, and
completing the purchase of the chosen itinerary on behalf of the buyer.

27. The computer-readable storage medium of claim 26, wherein the plurality of selected itineraries are all associated with the same destination.

28. The computer-readable storage medium of claim 26, wherein the plurality of selected itineraries have different departure dates.

29. The computer-readable storage medium of claim 26, wherein the plurality of selected itineraries are all non-overlapping in time.

30. The computer-readable storage medium of claim 26, wherein at least some of the plurality of selected itineraries are opaque, in that at least some of the itinerary details are hidden from the buyer until after the purchase is complete.

31. The computer-readable storage medium of claim 30, wherein the details are hidden until immediately after the purchase is complete.

32. The computer-readable storage medium of claim 30, wherein the details are hidden until a predefined period of time after the purchase is complete.

33. The computer-readable storage medium of claim 26, wherein one or more of the selected itineraries has a total fare including discounts which is lower than a fare for a corresponding itinerary being sold on an open market.

34. The computer-readable storage medium of claim 26, wherein each of the plurality of selected itineraries specifies the following:
a destination;
a schedule;
a fare; and
a discount.

35. The computer-readable storage medium of claim 26, wherein each of the plurality of selected itineraries specifies travel party information for one or more travelers who all get booked on the same itineraries.

36. The computer-readable storage medium of claim 26, wherein each of the selected itineraries comprises a package which includes an air travel ticket and at least one of:
a hotel room;
a rental car; and
another travel-related product.

37. The computer-readable storage medium of claim 26, wherein each of the selected itineraries provides one of the following modes of transportation:
airplane;
train;
bus; and
ship.

38. The computer-readable storage medium of claim 13, wherein a provider of the chosen itinerary completes a monetary transaction associated with the purchase of the chosen itinerary.

39. The computer-readable storage medium of claim 38, wherein the provider redirects the buyer to a third-party website to complete the monetary transaction.

40. The computer-readable storage medium of claim 39, wherein the third-party website belongs to the inventory provider.

41. The computer-readable storage medium of claim 39, wherein the provider imbeds an iframe into the third-party website.

42. The computer-readable storage medium of claim 39, wherein the provider is given a web subdomain by the third party.

43. The computer-readable storage medium of claim 26, wherein the plurality of selected itineraries are contained in a shopping cart, and wherein an itinerary provider can dynamically adjust a list of products available to the buyer based on changes to the contents of the shopping cart.

44. The computer-readable storage medium of claim 43, wherein the dynamic adjustment is based on an adjustment criterion which accounts for distances between destination airports.

45. The computer-readable storage medium of claim 43, wherein the dynamic adjustment is based on an adjustment criterion which is based on a set of travel providers for itineraries in the shopping cart as compared to a set of travel providers for candidate itineraries.

46. The computer-readable storage medium of claim 26, wherein the plurality of selected itineraries are contained in a shopping cart, and wherein the buyer may edit the shopping cart by removing prior selections or by modifying a composition of a seller-created shopping cart.

47. A computer-readable storage medium storing instructions that when executed by a computer cause the computer to perform a method for facilitating a purchase of a travel itinerary subject to date uncertainty, the method comprising:
receiving, at a computer system, a plurality of selected itineraries from a buyer, wherein the plurality of selected itineraries includes a first itinerary associated with a first date and a second itinerary associated with a second date; and
upon receiving, at the computer system, an agreement from the buyer to purchase an unspecified one of the plurality of selected itineraries;
choosing two or more of the plurality of selected itineraries for the buyer,
allowing the buyer to select a final itinerary from the two or more chosen itineraries, and
completing the purchase of the final itinerary on behalf of the buyer.

48. The computer-readable storage medium of claim 47,
wherein upon receiving the agreement from the buyer to purchase an unspecified one of the plurality of selected itineraries, the method further comprises collecting a deposit from the buyer; and
wherein completing the purchase of the final itinerary on behalf of the buyer involves collecting a balance of the purchase price less the deposit for the final itinerary.

49. A computer-readable storage medium storing instructions that when executed by a computer cause the computer to perform a method for facilitating a purchase of a travel itinerary subject to destination uncertainty, the method comprising:
receiving, at a computer system, a plurality of dates from a buyer; and
upon receiving, at the computer system, an agreement from the buyer to purchase an itinerary for an unspecified one of the plurality of dates;
choosing a date for the buyer,
allowing the buyer to select an itinerary for the chosen date, and
completing the purchase of the selected itinerary on behalf of the buyer.

50. The computer-readable storage medium of claim 49,
wherein upon receiving the agreement from the buyer to purchase an itinerary for an unspecified one of the plurality of dates, the method further comprises collecting a deposit from the buyer; and
wherein completing the purchase of the selected itinerary on behalf of the buyer involves collecting a balance of the purchase price less the deposit for the selected itinerary.

51. A computer system that facilitates a purchase of a travel itinerary subject to date uncertainty, comprising:
a processor;
a memory; and
an application configured to receive a plurality of selected itineraries from a buyer, wherein the plurality of selected itineraries includes a first itinerary associated with a first set of dates and a second itinerary associated with a second set of dates;
wherein upon receiving an agreement from the buyer to purchase an unspecified one of the plurality of selected itineraries, the application is configured to,
choose one of the plurality of itineraries for the buyer, and
complete the purchase of the chosen itinerary on behalf of the buyer.

52. A computer system that facilitates a purchase of a travel itinerary subject to date uncertainty, comprising:
a processor;
a memory; and
an application configured to receive a plurality of selected itineraries from a buyer, wherein the plurality of selected itineraries includes a first itinerary associated with a first date and a second itinerary associated with a second date; and
wherein upon receiving an agreement from the buyer to purchase an unspecified one of the plurality of selected itineraries, the application is configured to,
choose two or more of the plurality of selected itineraries for the buyer,
allow the buyer to select a final itinerary from the two or more chosen itineraries, and
complete the purchase of the final itinerary on behalf of the buyer.

53. A computer system that facilitates a purchase of a travel itinerary subject to date uncertainty, comprising:
a processor;
a memory; and
an application configured to receive a plurality of dates from a buyer; and
wherein upon receiving an agreement from the buyer to purchase an itinerary for an unspecified one of the plurality of dates, the application is configured to,
choose a date for the buyer,
allow the buyer to select an itinerary for the chosen date, and
complete the purchase of the selected itinerary on behalf of the buyer.
